(19) United States
(12) Patent Application Publication
(10) Pub. No.: US 2008/0218870 A1
(43) Pub. Date: Sep. 11, 2008

(54) Head-Up Display Comprising a Deformable Mirror

(75) Inventors: Britta Lind, Mainhausen (DE); Bernd Ludewig, Hirschberg (DE); Ralf Mayer, Bolanden (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens VDO Automotive AG, Regensburg (DE)

(21) Appl. No.: 11/794,842

(22) PCT Filed: Dec. 9, 2005
(86) PCT No.: PCT/EP2005/056628

§ 371 Date: Oct. 18, 2007

(30) Foreign Application Priority Data
Jan. 5, 2005 (DE) 10 2005 000 871.2

(51) Int. Cl. G02B 27/01

(52) U.S. Cl. 359/630

(57) ABSTRACT

The invention relates to a head-up-display (1) comprising an image generating unit (13, 7, 8) and at least one mirror (9, 10) which is arranged in the beam path (2) downstream from the image generating unit (13; 7, 8). Traditional head-up-displays (1) require an expensive adjusting element by taking into account the individual geometry of the built-in windscreen (WS) for good image quality. According to the invention, the mirror (9, 10) is embodied in such a manner that it can be deformed by adjusting elements (15, 16) in order to facilitate the control thereof.

The invention relates to a head-up display having an image production unit and at least one mirror which is arranged in the beam path downstream from the image production unit.

The preferred field of application for the subject matter of the invention is automobile construction, where apparatuses are already in use in specific cases by means of which information is reflected onto the windshield, superimposed on the image of the surrounding area, such that it can be perceived by the driver. The apparatus optics are subject to stringent requirements for good imaging quality of the virtual head-up display image that is displayed to the driver in the surrounding area. Major problems result from the fact that the windshield is likewise part of the image optics, in the form of a mirror. Even minor deformation of the windshield is sufficient for the virtual image to appear inclined with respect to a nominal state, or to be distorted. The tolerances for installation of a windshield in the bodywork exceed the precision limits which would be necessary for good imaging quality of the head-up display. It is in the nature of tolerances that the geometry of the windshield and the relative position with respect to attachment points of the head-up display are more or less random in the significant order of magnitude, thus until now necessitating highly complex manual adjustment of the head-up display relative to the windshield, for acceptable imaging quality. In this case, however, to a greater or less extent only inclination position corrections have been possible, by moving the head-up display attachment points. The image distortion which results virtually randomly from the manufacturing and installation tolerances of the windshield cannot be corrected in this way.

An apparatus of the described type is already known from German Laid-Open Specification DE 39 29 842 A1.

In order to solve the problem, the invention proposes that the mirror be designed to be deformable.

In this case, it is particularly expedient to use plastic mirrors since they can be produced at low cost by injection molding. Deformation of at least one mirror makes it possible in particular to correct for typical deformation on windshields, in that the mirror is attached only at specific points, for example subsections of a contact surface, and has a bending force applied to it at other points, by means of a moving bearing.

The advantages of the invention are fully evident if the mirror is also designed such that it can be moved—that is to say such that it can be moved linearly and/or can be rotated—preferably while retaining its shape and surface contour. This additionally allows position correction of the indicated virtual image by adjustment of the mirror. This means that there is no longer any need to adjust the entire head-up display by adjusting the contact points, thus advantageously allowing particularly solid and simple mounting of the head-up display in the motor vehicle, without any adjustment capability.

In this case, it is worthwhile designing the mounting for the mirror on a holder such that the holder holds and fixes the mirror in a predetermined shape. The holder may also expediently have contact surfaces for the mirror, and packing elements for the mirror may be provided on the contact surfaces, and are arranged between the contact surfaces and the mirror. Besides or additionally, it is worthwhile in this case for the mirror if required to be firmly connected to contact surfaces only at points or on lines, and to have the capability to be deformed in the rest of its area, preferably in the edge or corner area, for example by means of packing elements or actuating elements, such that the shape and position of the windshield are compensated for by the shape of the mirror, with the aim of displaying the virtual image without any distortion. A configuration of a holder having at least one actuating element by means of which the mirror can be deformed is particularly expedient. In this case, the actuating element may have a piezo-actuator, for example, may be an electromagnetic actuating element, or may be equipped with a servomotor, which drives, preferably actuated from a central controller, cause the mirror to be deformed for matching to a nominal state of the virtual image. Besides or additionally, the actuating element may have an actuating screw, possibly driven by the drives that have already been mentioned by way of example, allowing precise adjustment of the mirror shape and mirror position. Electromagnetic actuating elements are also cost-effective and expedient.

A particularly compact head-up display configuration is obtained by the holder being a component of a housing in which the image production unit is arranged. In this case, contact surfaces for the mirror and precautions for an actuating element may be formed directly on the housing, thus advantageously reducing the range of components. Furthermore, the stiffness of a housing of a regular shape, preferably in the form of a box, has a positive effect on the position stability of the mirror. In this case, the requirements for the tolerances of the housing in the area of the mirror are relatively low, since the mobility according to the invention or deformability of the mirror make it possible to compensate for inaccuracies in the housing, without any additional effort. Compensation for virtually all feasible deformation of the windshield is possible if the mirror has a free-form surface. This free-form surface may in this case be matched to the fixing points of the mirror and to the mounting points of the mirror on actuating elements, such that typical distortion resulting from deformation of the windshield during its installation can be corrected by means of only a small number of actuating elements, and possibly only one actuating element. An apparatus according to the invention is particularly worthwhile when a controller is provided which drives the actuating element on the basis of a predetermined correction parameter set, such that the mirror is deformed in a specific manner.

The correction parameter set may in this case be the result of an analysis of measured values describing the actual individual geometry of the relevant position of the contact points of a head-up display with respect to the windshield of a motor vehicle. A measurement such as this can be carried out directly or indirectly by first of all installing the head-up display in a first position and reflecting a reference image onto the windshield, thus allowing the definition of the relevant geometric relationships of the relative position of the head-up display with respect to the windshield, by means of reference points. This may be done, for example, by means of a recording sensor system in the viewing area (eye box) for the head-up display and an evaluating computation unit, which uses the measured values to determine the correction parameter set for driving the actuating elements.

The invention will be explained in the following text using one specific exemplary embodiment and with reference to schematic illustrations, in which:

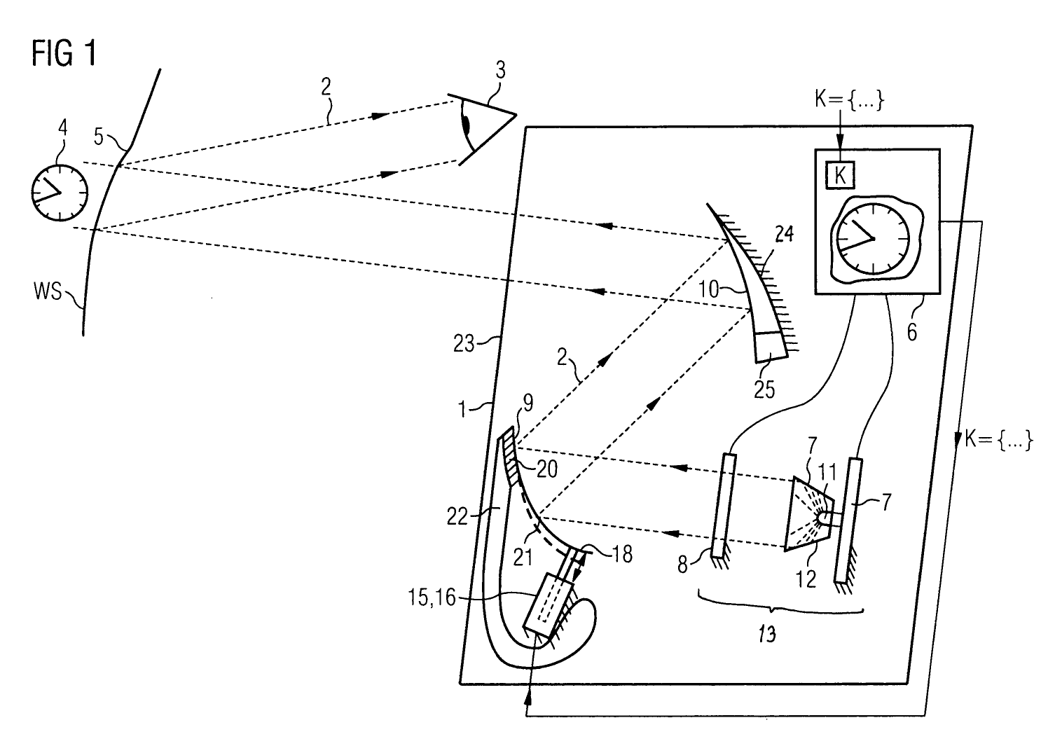

FIG. 1 shows a schematic illustration of one specific exemplary embodiment of the invention.

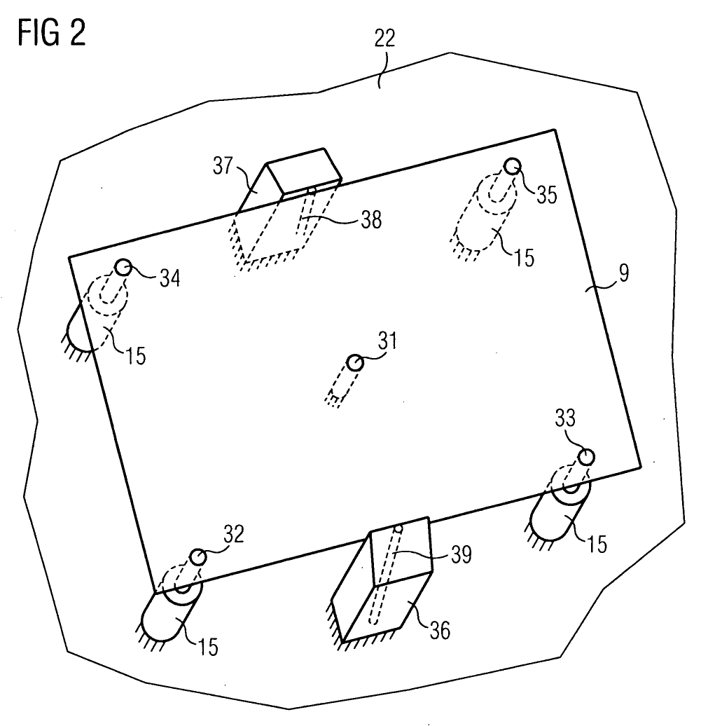

FIG. 2 shows a schematic three-dimensional illustration of a deformable mirror with actuating elements.

The illustration in FIG. 1 shows a head-up display 1 interacting with a windshield WS on which a beam path 2 is reflected in such a way that a virtual image 4 is presented to a viewer 3. The windshield WS is subject to deformation 5 originating from the installation and production process. This deformation 5 means that the viewer 3 is displayed a virtual image 4 which is distorted and inclined when using a conventional head-up display.

The head-up display 1, which is illustrated in the simplified form, has as its major modules a controller 6, a light source 7, a display 8 through which the light from the light source 7 passes, and two mirrors 9, 10 which deflect the beam path 2. The light source 7 produces the light required for passing through the display 8 by means of a plurality of light-emitting diodes 11 which emit their light in a reflector 12, which produces an essentially parallel beam path 2 from the injected light. In conjunction with one another, the light source 7 and the display 8 form an image production unit 13, which is driven by means of the controller 6.

The first mirror, which follows the image production unit 13 in the beam path 2, can move and is deformable, and can be adjusted to a specific shape and position by means of an actuating element 15, based on requirements from the controller 6. The actuating element 15 is in this case a piezo-actuator 16 and allows one-dimensional movement of an actuating element, which is used as a mounting contact in the area of one edge 18 of the mirror 9. In a first area 20, the mirror 9 is fitted firmly to a holder 22, and it is mounted such that it can be moved on an actuating element 15 in a second area 21, with this actuating element 15 likewise being attached to the holder 22. In this specific embodiment, the holder 22 is a component of a housing 23 which surrounds the head-up display 1.

The second mirror 10, which follows the first mirror 9 in the beam path, is partially attached to a contact surface 24, and its shape and position are adjusted in the unfixed area by means of a packing element 25, which is attached there in a detachable form.

The controller 6 controls the deformation of the first mirror 9 on the basis of the requirement from a correction parameter set K, by driving the actuating element 15 to move through a predetermined distance.

FIG. 2 shows a deformable rectangular mirror 9 according to the invention, fitted to a holder 22. In the area of the geometric center 31 of the mirror surface, the mirror is mounted such that it is static at that point, but can be spatially rotated. A mounting point 32, 33, 34, 35 is located at each of the corners, at which the position of the mounted area of the mirror 9 can be varied by means of in each case one actuating element 15, deforming the mirror 9, in a direction essentially at right angles to the plane of the undeformed mirror 9. This makes it possible to correct for typical errors in the imaging of the reflection onto the windshield WS. Two mountings 36, 37 are located in the area of the edge of the mirror 9, which each allow one-dimensional transverse movement of the mounted point of the mirror 9 along a curve 38, 39, and otherwise restrict the movement degrees of freedom there.

1.-14. (canceled)

15. A head-up display, comprising:
an image production unit producing light directed along a beam path; and
at least one mirror arranged downstream of said image production unit in the beam path, said at least one mirror being deformable.

16. The head-up display of claim 15, further comprising at least one actuating element fitted to said at least one mirror and actuatable to deform said at least one mirror.

17. The head-up display of claim 16, wherein said at least one actuating element comprises a plurality of actuating elements fitted at mounting points on said at least one mirror such that at least one corner of said at least one mirror is movable relative to other areas of said at least one mirror in response to said actuating elements, such that said at least one mirror is deformable.

18. The head-up display of claim 17, wherein at least one point of said at least one mirror is spatially fixed in said housing.

19. The head-up display of claim 17, wherein said at least one mirror is rectangular.

20. The head-up display of claim 17, wherein said mirror is mounted at five mounting points, each of at least four of said mounting points are connected to a respective one of said actuating elements such that said each of at least four of said mounting points is movable relative to one another in response to said actuating elements.

21. The head-up display of claim 15, wherein said mounting is configured to hold said mirror in a predetermined shape.

22. The head-up display of claim 16, wherein said at least one actuating element has a piezo-actuator.

23. The head-up display of claim 16, wherein said at least one actuating element has a servomotor.

24. The head-up display of claim 16, wherein said at least one actuating element has an actuating screw.

25. The head-up display of claim 17, further comprising a holder provided for said at least one mirror having contact surfaces and packing elements, said at least one mirror being attached to said contact surfaces, said packing elements being adjustably connected to said at least one mirror for adjusting the shape and position of the non-fixed areas of said at least one mirror.

26. The head-up display of claim 15, further comprising a housing in which said image production unit and said at least one mirror are arranged.

27. The head-up display of claim 15, wherein said at least one mirror has a free-form surface.

28. The head-up display of claim 17, further comprising a controller connected for driving said actuating elements based on a predetermined correction parameter set (K) such that said at least one mirror is deformed in a specific manner.
